(19) United States
(12) Patent Application Publication
(10) Pub. No.: US 2014/0285302 A1
(43) Pub. Date: Sep. 25, 2014

(54) HIGH VOLTAGE TRANSFORMER

(71) Applicant: Munsu SIN, Seoul (KR)

(72) Inventor: Munsu SIN, Seoul (KR)

(21) Appl. No.: 14/219,670

(22) Filed: Mar. 19, 2014

(30) Foreign Application Priority Data
Mar. 19, 2013 (KR) 10-2013-0028889

(51) Int. Cl. H01F 38/00; H01F 27/29

(52) U.S. Cl. CPC H01F 38/00; H01F 27/29
USPC 336/192; 336/220

(57) ABSTRACT

Provided is a high voltage transformer. The high voltage transformer includes a core, a primary coil part wound around the core, the primary coil part receiving alternating current (AC) power, and a secondary coil part in which a high voltage supplied to a magnetron is induced by the primary coil part, the secondary coil being wound around the core. The primary coil part includes a plurality of even number of coils having the same turn number.

### CROSS-REFERENCE TO RELATED APPLICATION(S)

The present application claims priority under 35 U.S.C. 119 and 35 U.S.C. 365 to Korean Patent Application No. 10-2013-0028889 (filed on Mar. 19, 2013), which is hereby incorporated by reference in its entirety.

### BACKGROUND

1. Field

The present disclosure relates to a high voltage transformer.

Generally, a high voltage transformer for a cooking appliance is configured to boost a household voltage of about 100 v to about 220 V into a high voltage.

FIG. 1 is a view illustrating a circuit of a high voltage transformer for a cooking appliance according to a related art. When a common alternating current (AC) power 10 of about 100 V to about 200 V, which is introduced into a household is input to a primary coil 40, the common AC power is boosted into a high voltage to correspond to turn numbers of primary and secondary coils 40 and 60 and thus is output as a driving voltage for a magnetron 20.

The above-described voltage that is output from the high voltage transformer for the cooking appliances may be obtained by following formula 1 according to a relationship between a turn number N1 and a primary voltage V1 and between a turn number N2 and a secondary voltage V2.

N1/N2=V1/V2 (Equation 1)

Thus, to generate a high voltage at the secondary coil of a winding-type high voltage transformer, the high voltage transformer has to be designed so that the turn number N1 of primary coil 40 increases, or the turn number of secondary coil 60 decreases.

In the related art, in a state where the turn number N2 of secondary coil 60 is fixedly maintained, when voltages of about 110 V and about 220 V are respectively used as input voltages, the high voltage transformer may be designed so that the turn number N1 of primary coil 40 varies.

That is, in case of Korea, a voltage of 220 V is used as a common power. However, in case of USA, Canada, Japan, Taiwan, Libya, Venezuela, Panama, Jamaica, Guam and so on, a voltage of 110 V is used as the common power. Also, in case of France, Belgium, Italy, China, Vietnam, Indonesia, Saudi Arabia, Brazil, and so on, voltages of 110 V and 220 V are used as the common power.

Therefore, in the related art, the high voltage transformer is designed so that the turn number N of primary coil 40 varies by input voltages different from each other according to the countries. Thus, since the high voltage transformer for the cooking appliances is manufactured for each country on the basis of different standards for the countries, the countries do not commonly use the high voltage transformer.

### SUMMARY

Embodiments provide a high voltage transformer.

In one embodiment, a high voltage transformer includes: a core; a primary coil part wound around the core, the primary coil part receiving alternating current (AC) power; and a secondary coil part in which a high voltage supplied to a magnetron is induced by the primary coil part, the secondary coil being wound around the core, wherein the primary coil part includes a plurality of even number of coils having the same turn number.

In another embodiment, a high voltage transformer includes: a core; a primary coil part wound around the core, the primary coil including first and second coils; and a secondary coil part to which a high voltage supplied to a magnetron is induced by the first and second coils, the secondary coil being wound around the core, wherein each of the first and second coils includes a coil terminal.

The details of one or more embodiments are set forth in the accompanying drawings and the description below. Other features will be apparent from the description and drawings, and from the claims.

### BRIEF DESCRIPTION OF THE DRAWINGS

The embodiments will be described in detail with reference to the following drawings in which like reference numerals refer to like elements wherein:

FIG. 1 is a view illustrating a circuit of a high voltage transformer for a cooking appliance according to a related art.

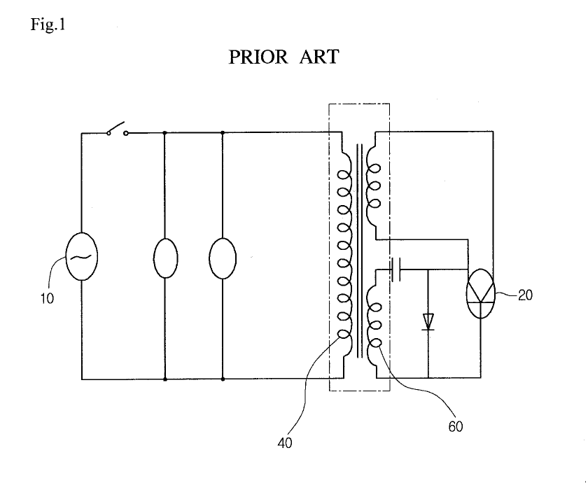

FIG. 2 is a view illustrating an outer appearance of a high voltage transformer for a cooking appliance according to an embodiment.

FIG. 3 is a view illustrating a circuit of the high voltage transformer for the cooking appliance according to an embodiment.

FIG. 4 is a view illustrating a connection structure of the high voltage transformer for the cooking appliance when an input voltage of about 220 V is applied according to an embodiment.

FIG. 5 is a view illustrating a connection structure of the high voltage transformer for the cooking appliance when an input voltage of about 110 V is applied according to an embodiment.

### DETAILED DESCRIPTION

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

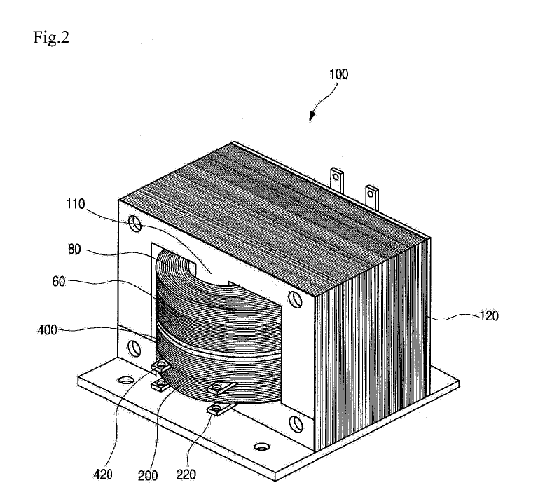

FIG. 2 is a view illustrating an outer appearance of a high voltage transformer for a cooking appliance according to an embodiment.

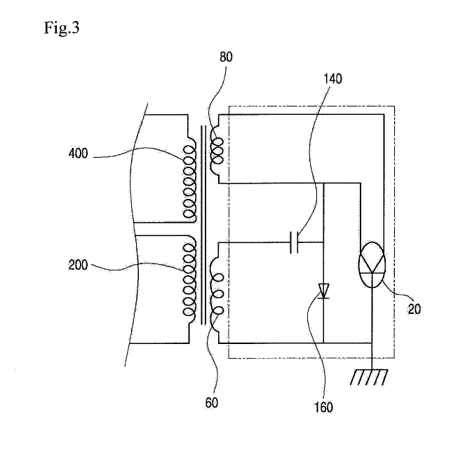

Referring to FIGS. 2 and 3, a high voltage transformer 100 for a cooking appliance according to an embodiment may be an apparatus which receives alternating current (AC) power to supply a high voltage power to a magnetron 20 by electromagnetic induction. The high voltage transformer 100 includes a core 120 in which a plurality of iron pieces are stacked and fixed and input and output coils, which are wound around a central shaft 110 of the core 120 several times.

In detail, primary coil parts 200 and 400 to which an input power is applied are wound around the central shaft of the core 120. Here, the primary coil parts 200 and 400 include an even number of primary coils having the same turn number.

That is, the high voltage transformer 100 for the cooking appliance according to an embodiment includes the even number of coils which have the same turn number to correspond to common powers of about 110 V and about 220 V by using the primary coil. The high voltage transformer 100 may adjust the turn number according to a connection method of the even number of primary coils to receive the common AC power of about 110 V or about 220 V, thereby amplifying the received common AC power into the high voltage.

A secondary coil part 60 is wound around the central shaft 110 above the primary coil parts 200 and 400, and a magnetron heating coil 80 is disposed above the secondary coil part 60 to generate an oscillating voltage of about 3.3 V to about 4 V for the magnetron 20.

When a power is supplied to the primary coil parts 200 and 400, a high voltage is induced to the secondary coil part 60 to transfer the induced high voltage to the magnetron 20.

For this, the secondary coil part 60 is connected to a high voltage capacitor 140 and a high voltage diode 160. An output of the high voltage transformer 100 is determined by capacity of the high voltage capacitor 140.

Hereinafter, the output of the high voltage transformer 100 for the cooking appliance according to an embodiment is determined, and then a connection structure according to the determined output will be described with reference to accompanying drawings.

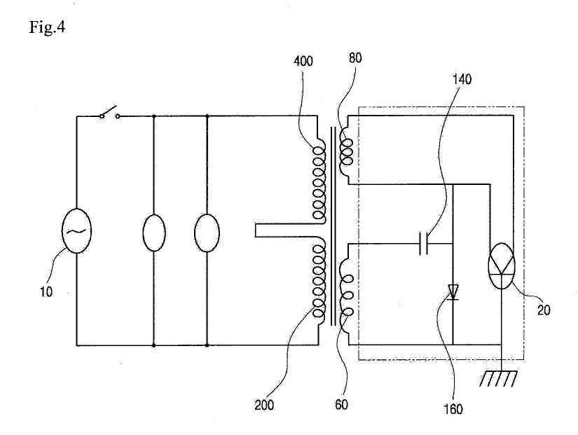

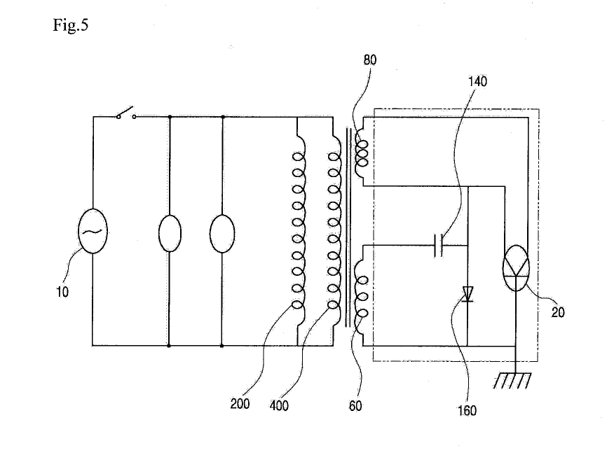

FIG. 4 is a view illustrating a connection structure of the high voltage transformer for the cooking appliance when an input voltage of about 220 V is applied according to an embodiment, and FIG. 5 is a view illustrating a connection structure of the high voltage transformer for the cooking appliance when an input voltage of about 110 V is applied according to an embodiment.

As described above, in the high voltage transformer 100 for the cooking appliance according to an embodiment, the primary coil parts 200 and 400 include the even number of coils having the same turn number. For example, although the primary coil parts 200 and 400 include a first coil 200 and a second coil 400 in FIG. 5, the present disclosure is not limited thereto.

According to above described constitutions, in the current embodiment, the connection structure may vary according to a required output voltage in a state where the even number of primary coils are wound around the central shaft 110.

The output of the high voltage transformer 100 for the cooking appliance according to the current embodiment may be determined by the capacity of the high voltage capacitor 140, which serves as a load of a secondary terminal.

That is, current applied to the primary coil parts 200 and 400 may be determined according to the capacity of the high voltage capacitor 140. When temperature rise of the primary coil parts 200 and 400 is determined, a voltage and current induced to the secondary coil part 60 may be determined.

Since a magnetic flux due to the current applied to the primary coil parts 200 and 400 flows through the core 120, staking of the core 120 may be determined. The above described conditions may be combined to determine the turn numbers of the primary coil parts 200 and 400 and the turn number of secondary coil part 60, and then a line diameter of each of the primary and secondary coils and the stacking of the core 120 are determined in consideration of the temperature rise value.

When the high voltage transformer 100 for the cooking appliance is constituted as described above, the first coil 200 on which a first coil terminal 220 is disposed has the same turn number N as the second coil 400 on which a second coil terminal 420 is disposed. Thus, when the first and second coils 200 and 400 are connected to each other in series, the turn number N of first coil 200 is added to that of the second coil 400 to induce the coil voltage to the secondary coil.

That is, when the first and second coils 200 and 400 which are wound N times are connected to each other in series, the primary coil parts 200 and 400 are wound 2N times. And thus, a voltage generated from the coil that is wound around the primary coil parts 200 and 400 2N times may be induced to the secondary coil 60.

On the other hand, as illustrated in FIG. 5, when the first and second coils 200 and 400 are connected to each other in parallel, a voltage of a coil that is wound N/2 times is generated at the first coil 200, and a voltage of a coil that is wound N/2 times is generated at the second coil 400. Finally, the voltage of the primary coil is equal to that of the coil that is wound N times.

Therefore, the high voltage transformer 100 for the cooking appliance according to the current embodiment may be designed without changing the tune numbers of primary coil parts 200 and 400 after current applied to the primary coil parts 200 and 400 is determined according to the capacitance of the high voltage capacitor 140. As a result, the connection structure between the first and second coils 200 and 400 may be adjusted to correspond to the input voltage.

The high voltage transformer 100 may be applied to the cooking appliance. The cooking appliance may include a cavity in which foods are accommodated and the magnetron 20 for supplying a microwave to the cavity. Here, the high voltage transformer 100 may supply the high voltage to the magnetron 20.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A high voltage transformer comprising:
a core;
a primary coil part wound around the core, the primary coil part to receive alternating current (AC) power, the primary coil part including an even number of coils having a same turn number; and
a secondary coil part wound around the core, wherein the primary coil part to induce a high voltage to be supplied to a magnetron.

2. The high voltage transformer according to claim 1, wherein when a power is supplied to the primary coil part, the high voltage is induced to the secondary coil part to transfer the induced high voltage to the magnetron.

3. The high voltage transformer according to claim 1, wherein the primary coil part includes:
a first coil wound N number of times around the core; and
a second coil wound N number of times around the core, the second coil being connected in series to the first coil.

4. The high voltage transformer according to claim 3, wherein the first coil includes a coil terminal, and the second coil includes a coil terminal.

5. The high voltage transformer according to claim 3, wherein the primary coil part to receive an input voltage within a range of approximately 100 V to approximately 120 V.

6. The high voltage transformer according to claim 3, wherein a total turn number of the secondary coil part is the same as a sum of the N number of times of the first coil and the N number of times of the second coil.

7. The high voltage transformer according to claim 1, wherein the primary coil part includes:
a first coil wound N number of times around the coil; and
a second coil wound N number of times around the coil, the second coil being connected in parallel to the first coil.

8. The high voltage transformer according to claim 7, wherein the first coil includes a coil terminal, and the second coil includes a coil terminal.

9. The high voltage transformer according to claim 7, wherein the primary coil part to receive an input voltage within a range of approximately 200 V to approximately 240 V.

10. The high voltage transformer according to claim 1, further comprising a magnetron heating coil wound around the core to generate an oscillating voltage for the magnetron.

11. The high voltage transformer according to claim 10, wherein the primary coil part, the secondary coil part, and the magnetron heating coil are successively wound around the core.

12. The high voltage transformer according to claim 1, further comprising:
a high voltage capacitor and a high voltage diode, and an output of the transformer is based on a capacity of the high voltage capacitor.

13. A high voltage transformer comprising:
a core;
a primary coil part wound around the core, the primary coil including a first coil and a second coil, wherein the first coil includes a coil terminal, and the second coil includes a coil terminal; and
a secondary coil part wound around the core, and the first and second coils of the primary coil part to induce a high voltage to be provided to a magnetron.

14. The high voltage transformer according to claim 13, wherein the first coil and the second coil are connected in series to supply a voltage of approximately 100 V to approximately 120 V to the primary coil part.

15. The high voltage transformer according to claim 13, wherein the first coil and the second coil are connected in parallel to supply a voltage of approximately 100 V to approximately 120 V to the primary coil part.

16. The high voltage transformer according to claim 13, wherein the primary coil part includes:
a first coil wound N number of times around the core; and
a second coil wound N number of times around the core, the second coil being connected in series to the first coil.

17. The high voltage transformer according to claim 13, wherein the primary coil part includes:
a first coil wound N number of times around the coil; and
a second coil wound N number of times around the coil, the second coil being connected in parallel to the first coil.

18. A high voltage transformer comprising:
a core;
a first coil part around the core to receive an alternate current (AC), the first coil part including a first coil having a coil terminal, and a second coil having a coil terminal, wherein the first coil is provided around the coil a same number of times as the second coil; and
a second coil part around the core, and the first and second coils of the primary coil part to induce a high voltage.

19. The high voltage transformer according to claim 18, wherein the second coil is connected in series to the first coil.

20. The high voltage transformer according to claim 18, wherein the second coil is connected in parallel to the first coil.

21. The high voltage transformer according to claim 18, wherein when power is supplied to the first coil and the second coil of the first coil part, the high voltage is induced to the second coil part to transfer the induced high voltage.

22. The high voltage transformer according to claim 18, further comprising a magnetron heating coil at the core to provide an oscillating voltage.
